(19) United States
(12) Patent Application Publication
(10) Pub. No.: US 2008/0084412 A1
(43) Pub. Date: Apr. 10, 2008

(54) LIQUID CRYSTAL DISPLAY DEVICE AND METHOD FOR DRIVING THE SAME

(75) Inventors: Hyeon Seok BAE, Asan-si (KR); Sang Chul LEE, Yongin-si (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-Si (KR)

(21) Appl. No.: 11/842,225

(22) Filed: Aug. 21, 2007

(30) Foreign Application Priority Data
Oct. 9, 2006 (KR) 10-2006-0097977

(51) Int. Cl. G09G 5/00; G09G 3/36

(52) U.S. Cl. 345/212; 345/204; 345/92

(57) ABSTRACT

A liquid crystal display (“LCD”) device and method of driving the same capable of eliminating pressure induced light leakage includes a liquid crystal display comprising an LCD panel having a plurality of gate lines, a plurality of data lines formed in a direction to intersect the plurality of gate lines, and a plurality of unit pixels respectively formed at intersection regions of the plurality of gate and data lines; a power circuit for generating a plurality of driving voltages for driving the LCD panel; a gate driving unit for driving the plurality of gate lines; a source driving unit for driving the plurality of data lines; and a timing control circuit for generating plurality of control signals for controlling the gate and source driving units, wherein the timing control circuit drives the LCD panel in a non-electric field state every predetermined frame.

This application claims priority to Korean Patent Application No. 10-2006-0097977, filed on Oct. 9, 2006, and all the benefits accruing therefrom under 35 U.S.C. §119, the contents of which in its entirety are herein incorporated by reference.

### BACKGROUND OF THE INVENTION

1. Field of the Invention

The present invention relates to a liquid crystal display (“LCD”) device and a method for driving the same, and more particularly, to an LCD device and method of driving the same, in which the effects of the phenomenon of light leakage due to pressure applied to the LCD from an external force (also referred to as a “fingerprint phenomenon”) are reduced.

2. Description of the Related Art

In general, an LCD comprises a thin film transistor (TFT) substrate formed with pixel electrodes, TFTs for switching respective pixels, a common electrode substrate formed with color filters, a common electrode, and liquid crystals sealed between the two substrates. The LCD displays an image thereon by driving the liquid crystals to control transmittance of light through the application of a voltage between the two substrates.

If an external force is applied to the surface of an LCD panel, such as, for example, by rubbing the LCD with a finger, a phenomenon occurs in which in which the fingerprint does not disappear, but remains on the screen. This “fingerprint” phenomenon of light leakage due to pressure (referred to hereinafter as “pressure induced light leakage”) occurs when the arrangement of liquid crystals is changed into a random state upon application of pressure to the panel, but the random state of the liquid crystals is not then restored back to a stable state once the pressure is removed.

Pressure induced light leakage becomes more severe in a patterned vertical alignment (“PVA”) mode LCD panel than in a twisted nematic (“TN”) or in-plane switching (“IPS”) mode LCD panel. This is because no distortion occurs in a field direction in a TN or IPS mode LCD panel even when pressure is applied, whereas a field distortion does occur in a PVA mode LCD panel, thereby resulting in a texture difference between respective domains. Furthermore, in certain types of PVA mode LCD panels, a pixel is formed in an elongated manner so as to maximize transmittance. Such panels require more time for the restoration of a liquid crystal arrangement and a field, which become distorted after pressure is applied. Thus, pressure induced light leakage lasts for a longer period of time in these devices.

### BRIEF SUMMARY OF THE INVENTION

Aspects of the present invention provide a liquid crystal display, wherein the effects of pressure induced light leakage are reduced, and a method for driving the liquid crystal display.

In an exemplary embodiment of the present invention, a liquid crystal display (“LCD”) device includes an LCD panel having a plurality of gate lines, a plurality of data lines formed in a direction to intersect the plurality of gate lines, and a plurality of unit pixels respectively formed at intersection regions of the plurality of gate and data lines; a power circuit for generating a plurality of driving voltages for driving the LCD panel; a gate driving unit for driving the plurality of gate lines; a source driving unit for driving the plurality of data lines; and a timing control circuit for generating plurality of control signals for controlling the gate and source driving units, wherein the timing control circuit drives the LCD panel in a non-electric field state at each of a predetermined frame.

In another aspect, the timing control circuit includes a data conversion unit for converting image data supplied from the outside into data signals conforming to a predetermined data transmission scheme and for supplying the data signals to the source driving unit; a control signal generation unit for generating the plurality of control signals for controlling the gate and source driving units; and a black data generation unit for generating a black data signal every predetermined frame and for providing the black data signal to the source driving unit.

In another aspect, the LCD includes a memory for storing the value of a target frame therein; a counter for counting the value of a current frame; and a comparator for comparing the value of the target frame stored in the memory with the value of the current frame counted in the counter and for outputting a black data generation unit control signal for controlling the black data generation unit or a data conversion unit control signal for controlling the data conversion unit.

The counter counts vertical synchronization signals among the plurality of control signals output from the control signal generation unit.

The comparator outputs the black data generation unit control signal whenever the value of the target frame stored in the memory and the value of the current frame counted in the counter match one other, and outputs the data conversion unit control signal whenever the value of the target frame stored in the memory and the value of the current frame counted in the counter do not match one other.

The black data generation unit control signal is input to the counter so that the counter is reset.

In another aspect, the timing control circuit includes a data conversion unit for converting externally supplied image data into data signals conforming to a predetermined data transmission scheme and for supplying the data signals to the source driving unit, and a control signal generation unit for generating the plurality of control signals for controlling the gate and source driving units; the power circuit includes a DC-to-DC converter for converting DC power into the plurality of driving voltages, and a switching unit for controlling the supply of the plurality of driving voltages output from the DC-to-DC converter to the gate and source driving units; and the switching unit interrupts the supply of at least a portion of the plurality of driving voltages to any one of the gate and source driving units at each predetermined frame.

In another aspect, the LCD includes a memory for storing the value of a target frame therein; a counter for counting the value of a current frame; and a comparator for comparing the value of the target frame stored in the memory with the value of the current frame counted in the counter, wherein the control signal generation unit receives an output signal from the comparator and generates a switching unit control signal for controlling the switching unit.

The counter counts vertical synchronization signals among the plurality of control signals output from the control signal generation unit.

In another aspect, the control signal generation unit includes a switching unit control signal generation circuit for generating the switching unit control signal, and the switching unit control signal generation circuit including a plurality of switching elements activated according to the output signal of the comparator only at the predetermined frame so as to output a switching unit disable signal to the switching unit; and a resistor and a capacitor for controlling the duration time of the disable signal.

The predetermined frame may be from the 60th frame to the 120th frame.

In another aspect, the LCD panel includes an upper substrate having a common electrode with a cut-out pattern formed therein; a lower substrate having a pixel electrode with a cut-out pattern formed therein; and liquid crystals disposed between the upper and lower substrates.

According to another exemplary embodiment of the present invention, a method for driving a liquid crystal display (“LCD”) device includes converting externally supplied image data into data signals conforming to a predetermined data transmission scheme; supplying the data signals to an LCD panel; and interrupting the supply of the data signals, generating a black data signal and supplying the black data signal to the LCD panel at each predetermined frame.

In another aspect, supplying the black data signal to the LCD panel includes setting the value of a target frame; counting the value of a current frame; and comparing the value of the target frame with the value of the current frame and supplying the black data signal to the LCD panel according to the result of the comparison.

According to another exemplary embodiment of the present invention a method for driving a liquid crystal display (“LCD”) device includes converting DC power into a plurality of driving voltages; supplying the plurality of driving voltages to an LCD panel; and interrupting the supply of at least a portion of the plurality of driving voltages at each predetermined frame.

In another aspect, stopping the supply of at least a portion of the plurality of driving voltages includes setting the value of a target frame; counting the value of a current frame; and comparing the value of the target frame with the value of the current frame and interrupting the supply of at least a portion of the plurality of driving voltages according to the result of the comparison.

The predetermined frame may be from the 60th frame to the 120th frame.

### BRIEF DESCRIPTION OF THE DRAWINGS

The above and other aspects, features and advantages of the present invention will become apparent from the following description of preferred embodiments given in conjunction with the accompanying drawings, in which:

FIG. 1 is a schematic view showing a configuration of a liquid crystal display (“LCD”) according to an embodiment of the present invention;

FIG. 2 is a schematic view showing a configuration of an LCD according to an embodiment of the present invention;

FIG. 3 is a schematic view showing a configuration of an LCD according to another embodiment of the present invention;

FIG. 4 is a timing chart of a portion of a control signal output from a control signal generation unit of the LCD shown in FIG. 3;

FIG. 5 is a schematic view showing a configuration of a switching unit control signal generation circuit of the LCD shown in FIG. 3;

FIG. 6 is a schematic sectional view showing a PVA mode LCD panel employed in the LCD according to the present invention;

FIGS. 7A and 7B are photographs illustrating surface states of a conventional LCD panel before and after an external force is applied thereto, respectively;

FIG. 8 is a table showing the time required for the effects of pressure induced light leakage to disappear after an external force is initially applied to a conventional LCD;

FIGS. 9A and 9B are flowcharts illustrating a method for driving an LCD according to an embodiment of the present invention; and

FIG. 10 is a flowchart illustrating a method for driving an LCD according to another embodiment of the present invention.

### DETAILED DESCRIPTION OF THE INVENTION

The present invention is described more fully hereinafter with reference to the accompanying drawings, in which exemplary embodiments of the invention are shown. The present invention may, however, be embodied in many different forms and should not be construed as limited to the exemplary embodiments set forth herein. Rather, these exemplary embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “lower” other elements or features would then be oriented “above” or “upper” relative to the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, embodiments of the present invention will be described in detail with reference to the accompanying drawings.

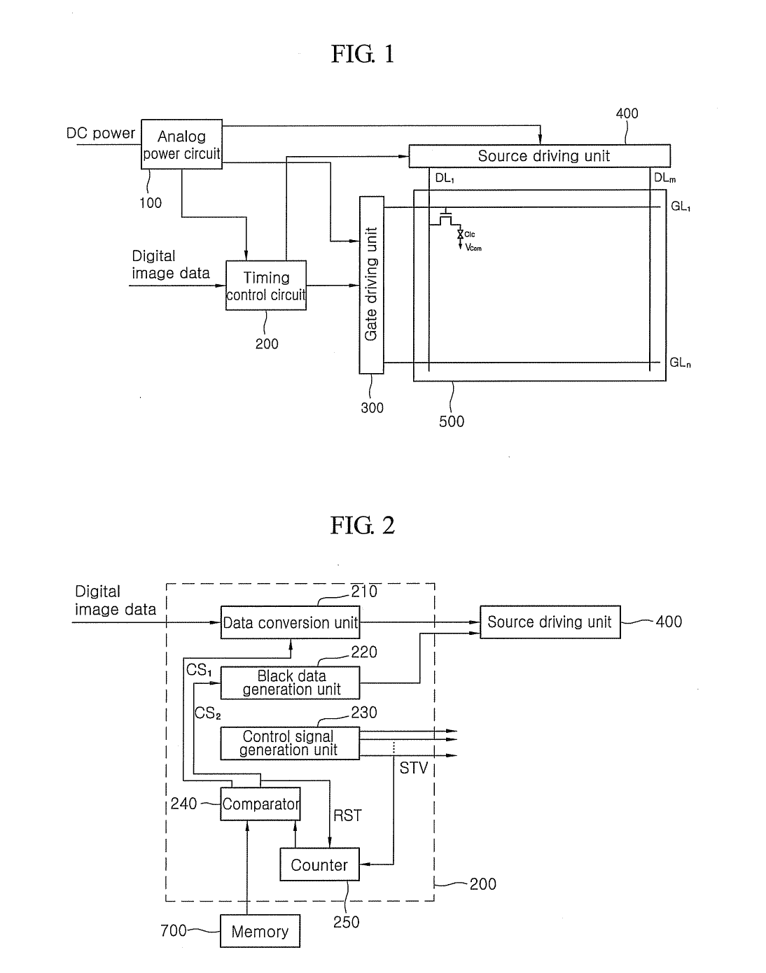

FIG. 1 is a schematic view showing a configuration of a liquid crystal display (“LCD”) according to an embodiment of the present invention.

Referring to FIG. 1, the LCD comprises an analog power circuit 100, a timing control circuit 200, a gate driving unit 300, a source driving unit 400, an LCD panel 500 and a backlight (not shown).

The analog power circuit 100 converts externally supplied DC power into various driving voltages, and then supplies the voltages to the timing control circuit 200, the gate driving unit 300 and the source driving unit 400. In an exemplary embodiment, the various driving voltages converted by and output from the analog power circuit 100 include a gamma reference voltage applied to liquid crystal cells, a TFT turn-on/off voltage for turning on/off TFTs of the LCD panel, and a common voltage, for example.

The timing control circuit 200 is configured to convert externally inputted digital image data into digital signals conforming to predetermined standards set such that the source driving unit 400 can process the digital signals. In addition, the timing control circuit 200 is configured to generate a plurality of control signals (e.g., a vertical synchronization signal (“STV”) for controlling the start of one frame, a clock signal (“CPV”) for generating a scan pulse, etc.) required for driving the gate and source driving units 300 and 400. Various signal transmission methods such as, for example, reduced swing differential signaling (“RSDS”), low voltage differential signaling (“LVDS”) and point-to-point differential signaling (“PPDS”) may be used for transmitting digital signals from the timing control circuit 200 to the source driving unit 400.

Furthermore, the timing control circuit 200 is configured to reduce the effects of pressure induced light leakage, which may occur when an external force is applied to a surface of the LCD panel 500, by driving the LCD panel 500 in a non-electric field state at each predetermined frame (e.g., a frame from the 60th to the 120th frame).

To this end, the timing control circuit 200 is configured to provide black data to the source driving unit 400 and/or to cut off a driving voltage supplied from the analog power circuit 100 to the LCD panel 500. An exemplary scheme for driving the LCD panel 500 in a non-electric field state will be discussed in greater detail below.

The gate driving unit 300 sequentially applies a TFT turn-on voltage to gate lines GL₁ to GLₙ formed in the LCD panel 500 through a scanning operation for a 1/60 second (a frequency of 60 Hz) representing a period of one frame. Further, the gate driving unit 300 constantly applies a TFT turn-off voltage to unselected gate lines. In an exemplary embodiment, the TFT turn-on voltage is generally on the order of about 15 to about 25 volts (V), and the TFT turn-off voltage is generally on the order of about −7 to about −5V.

The source driving unit 400 is configured to convert data signals supplied from the timing control circuit 200 into analog, liquid crystal cell voltages and to apply the analog voltages to data lines DL₁ to DLₘ. If the gate driving unit 300 selects any one of the gate lines to apply a TFT turn-on voltage thereto, all TFTs connected to the gate line are in a turn-on state. The source driving unit 400 outputs analog voltages corresponding to data signals, which are supplied to respective pixel electrodes, to the data lines and thence to respective liquid crystal cells through the turned-on TFTs.

The LCD panel 500 comprises a TFT substrate, a color filter substrate opposite to the TFT substrate, and liquid crystals disposed therebetween. The TFT substrate comprises, on a transparent insulative substrate, a plurality of gate lines GL₁ to GLₙ formed in a lateral direction to transmit gate signals therethrough and a plurality of data lines DL₁ to DLₘ formed to intersect the plurality of gate lines while being insulated therefrom; and a plurality of unit pixels respectively formed at intersection regions of the plurality of gate and data lines. In an exemplary embodiment, each of the unit pixels comprises a TFT and a pixel electrode.

As described above, if an LCD panel is driven in a non-electric field state by forcibly displaying black data or by cutting off a driving voltage supplied to the LCD panel at each predetermined frame, it is possible to minimize time required until the arrangement of liquid crystals and a field direction, which have been distorted upon application of pressure to the LCD panel, are restored to an original state. As a result, it is possible to reduce the effects of pressure induced light leakage in the LCD panel.

FIG. 2 is a schematic view showing a configuration of an LCD according to an embodiment of the present invention. Referring to FIG. 2, the timing control circuit 200 of the LCD supplies black data to the source driving unit 400 to drive an LCD panel in a non-electric field state at each predetermined frame. More specifically, the timing control circuit 200 of the LCD comprises a data conversion unit 210, a black data generation unit 220, a control signal generation unit 230, a comparator 240 and a counter 250.

The data conversion unit 210 is configured to convert externally supplied digital image data into data signals conforming to a predetermined data transmission scheme (e.g., RSDS) and subsequently to provide the converted data signals to the source driving unit 400.

The black data generation unit 220 generates black data signals at each predetermined frame (e.g., a frame from the 60th to the 120th frame), and provides the generated black data signals to the source driving unit 400 such that the corresponding LCD panel is driven in a non-electric field state. In an exemplary embodiment, the data signal output from the data conversion unit 210 is not provided to the source driving unit 400 during a frame corresponding to the one of the predetermined frames at which a black data signal is provided to the source driving unit 400. In other words, the data signals from the data conversion unit 210 and the black data signals from the black data generation unit 220 are selectively provided to the source driving unit 400.

The control signal generation unit 230, the comparator 240 and the counter 250 of the timing control circuit 200 and a memory 700 of the LCD are used to determine a frame at which a black data signal generated from the black data generation unit 220 is provided to the source driving unit 400.

The memory 700 stores the value of a target frame at which a black data signal is provided to the source driving unit 400. The counter 250 counts vertical synchronization signals (STV), each of which initiates the start of one frame, among a plurality of control signals generated from the control signal generation unit 230, so as to count the value of a current frame.

The comparator 240 compares the value of a target frame stored in the memory 700 with the value of a current frame counted in the counter 250, thereby outputting a data conversion unit control signal CS₁ for controlling the data conversion unit 210 or a black data generation unit control signal CS₂ for controlling the black data generation unit 220.

If the value of the target frame (e.g., 60th frame) stored in the memory 700 matches the value of the current frame counted in the counter 250, the comparator 240 outputs the black data generation unit control signal CS₂. Accordingly, the black data generation unit 220 generates a black data signal and provides the signal to the source driving unit 400. Further, the black data generation unit control signal CS₂ is input to the counter 250 so that the counter can be reset.

On the other hand, if the value of the target frame stored in the memory 700 does not match the value of the current frame counted in the counter 250, the comparator 240 outputs the data conversion unit control signal CS₁. Accordingly, the data conversion unit 210 provides a data signal to the source driving unit 400.

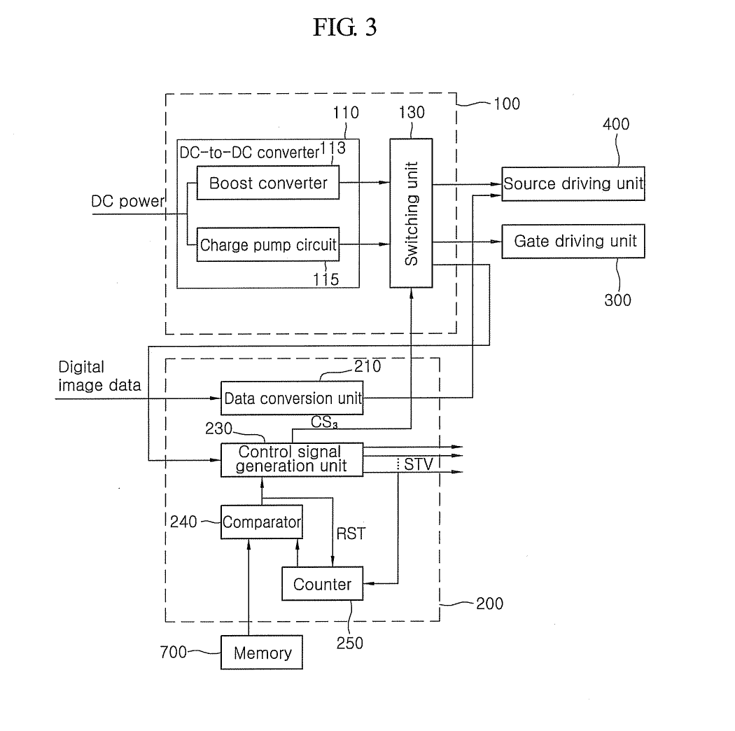

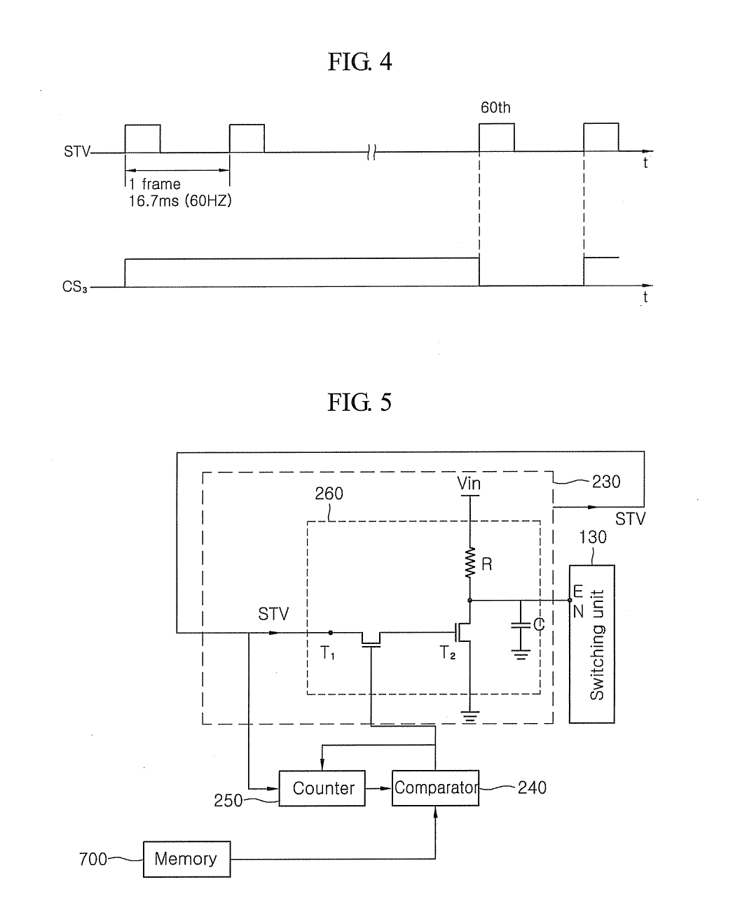

FIG. 3 is a schematic view showing a configuration of an LCD according to another embodiment of the present invention, FIG. 4 is a timing chart of a portion of a control signal output from a control signal generation unit of the LCD shown in FIG. 3, and FIG. 5 is a schematic view showing a configuration of a switching unit control signal generation circuit of the LCD shown in FIG. 3.

Referring to FIGS. 3 and 4, in order to drive an LCD panel in a non-electric field state at each predetermined frame, a timing control circuit 200 of the LCD is configured to cut off driving voltages supplied to gate and source driving units 300 and 400. In an exemplary embodiment, an analog power circuit 100 of the LCD comprises a DC-to-DC conversion unit 110 and a switching unit 130, and the timing control circuit 200 comprises a data conversion unit 210, a control signal generation unit 230, a comparator 240 and a counter 250.

The DC-to-DC converter 110 of the analog power circuit 100 is configured as a voltage level conversion circuit, such as a boost converter 113 and a charge pump circuit 115. The DC-to-DC converter 110 receives externally applied DC power and then converts it into a plurality of driving voltages. For example, the boost converter 113 generates a liquid crystal driving voltage (“AVDD”), and a common voltage (Vcom), while the charge pump circuit 115 generates a TFT turn-on/off voltage.

The switching unit 130 controls the application of the plurality of driving voltages (e.g., AVDD, the Vcom, the TFT turn-on/off voltage, etc.) to the gate and source driving units 300 and 400. The plurality of driving voltages output from the DC-to-DC converter 110 are either supplied to or cut off from the gate and source driving units 300 and 400, depending on turn-on/off of the switching unit 130.

The switching unit 130 is turned off at each predetermined frame (e.g., from the 60th to the 120th frame), in accordance with a switching unit control signal output from the timing control circuit 200 so as to cut off the supply of at least a portion of the plurality of driving voltages to at least one of the gate and source driving units 300 and 400. As a result, since a driving voltage is not supplied to the LCD panel, the LCD panel is driven in a non-electric field state, thereby eliminating pressure induced light leakage, which may occur on a surface of the LCD panel.

The timing control circuit 200 comprises the data conversion unit 210, the control signal generation unit 230, the comparator 240 and the counter 250.

The data conversion unit 210 converts externally supplied image data into data signals conforming to a predetermined data transmission scheme and provides the data signals to the source driving unit 400.

The control signal generation unit 230 generates a plurality of control signals for controlling the gate and source driving unit 300 and 400 (e.g., an STV, a CPV, etc.) and a switching unit control signal CS₃ for controlling the switching unit 130.

The control signal generation unit 230, the comparator 240 and the counter 250 of the timing control circuit 200 and the memory 700 of the LCD are used to determine a frame at which the switching unit 130 is turned off.

The memory 700 stores the value of a target frame at which the switching unit 130 is turned off. The counter 250 counts vertical synchronization signals STV, each of which notifies the start of one frame, among a plurality of control signals generated from the control signal generation unit 230, so as to count the value of a current frame.

The comparator 240 compares the value of a target frame stored in the memory 700 with the value of a current frame counted in the counter 250, and the control signal generation unit 230 generates a switching unit control signal CS₃ in accordance with the result of the comparator 240 and provides the switching unit control signal to the switching unit 130.

If the value of the target frame (e.g., the 60th frame) stored in the memory 700 matches the value of the current frame counted in the counter 250, the control signal generation unit 230 generates a switching unit control signal CS₃ as shown in FIG. 4, and provides the switching unit control signal to the switching unit 130. Thereby, the switching unit 130 is turned off at a corresponding frame, i.e., 60th frame interval, in accordance with such a switching unit control signal CS₃.

FIG. 5 illustrates a schematic view showing a configuration of a switching control signal generation circuit. Referring to FIG. 5, there is shown a schematic configuration of a switching unit control signal generation circuit 260 for generating a switching unit control signal in the control signal generation unit 230 of the timing control circuit 200. Although the switching unit control signal generation circuit 260 is depicted as being configured within the control signal generation unit 230 in the exemplary embodiment, it will be appreciated that it is not limited thereto. That is, the switching unit control signal generation circuit 260 may be separately configured outside the control signal generation unit 230.

The switching unit control signal generation circuit 260 comprises first and second switching elements T₁ and T₂, a resistor element R and a capacitor C. A gate terminal of the first switching element T₁ is connected to an output terminal of the comparator 250, a vertical synchronization signal STV output from the control signal generation unit 230 is input to a source terminal of the first switching element T₁, and a drain terminal of the first switching element T₁ is connected to a gate terminal of the second switching element T₂. The resistor element R is connected in series to a source terminal of the second switching element T₂, and the capacitor C is connected in parallel with the second switching element T₂. Further, a high voltage (Vin) and a low voltage (ground) are input to the source and drain terminals of the second switching element T₂, respectively.

An exemplary operation of the switching unit control signal generation circuit 260 having the aforementioned configuration is now discussed. The counter 250 counts vertical synchronization signals STV output from the control signal generation unit 230 to count the value of a current frame, and the comparator 240 compares the value of a target frame stored in the memory 700 with the value of the current frame counted in the counter 250. If both the values are identical, the comparator 240 turns on the first switching element T₁. When the first switching element T₁ is turned on, the second switching element T₂ is also turned on. Accordingly, a low voltage (i.e., a disable signal for turning off the switching unit) is output during a corresponding frame interval, so that a switching unit control signal CS₃ shown in FIG. 4 is output. The period of time during which the low voltage is output may be controlled by adjustment of the capacitance value of the capacitor C.

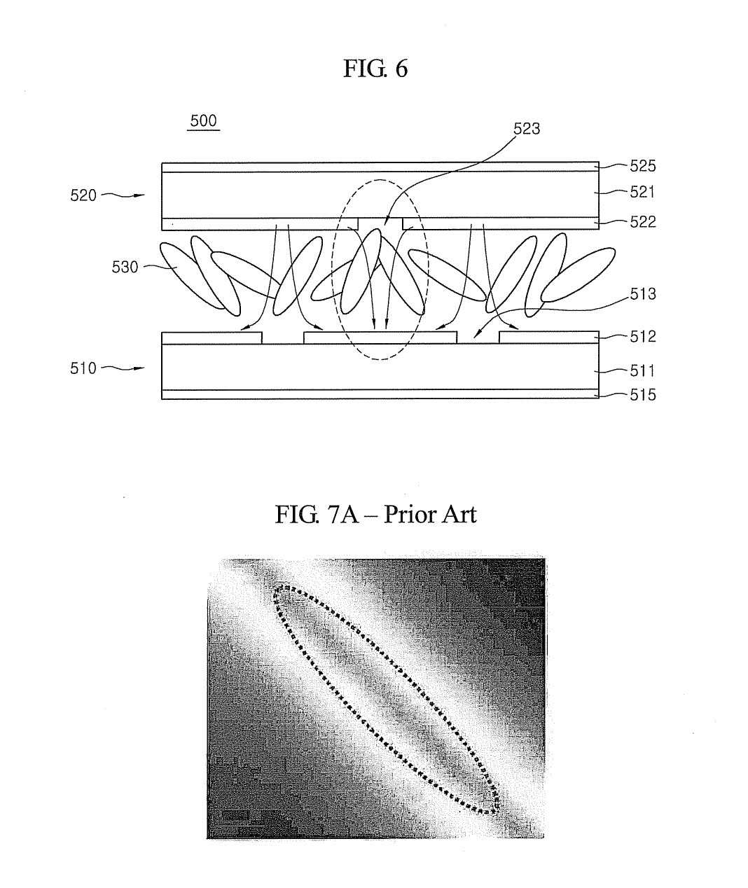

FIG. 6 is a sectional view schematically showing a PVA mode LCD panel employed in an LCD according to an embodiment of the present invention.

The PVA mode LCD panel 500 shown in FIG. 6 comprises a lower substrate 510 (e.g., a TFT substrate), an upper substrate 520 (e.g., a color filter substrate) opposite to the lower substrate, and liquid crystals 530 injected between the lower and upper substrates.

The lower substrate 510 further includes a transparent insulative substrate 511, a pixel electrode 512 formed on the substrate 511 and having a cut-out pattern with a predetermined shape formed in the pixel electrode 512, and a polarizing plate 515 attached to an outer surface of the substrate 511. The upper substrate 520 also comprises a transparent insulative substrate 521, a common electrode 522 formed on the substrate 521 and having a cut-out pattern with a predetermined shape formed in the common electrode 522, and a polarizing plate 525 attached to an outer surface of the substrate 521.

In a PVA mode LCD panel constructed as above, the patterns with the predetermined shapes are formed respectively in the pixel electrode of the lower substrate and the common electrode of the upper substrate, so that liquid crystals are aligned in various directions using a fringe field produced when a voltage is applied to liquid crystal cells. Since a texture difference occurs between respective domains due to field distortion produced, if an external force is applied in such a PVA mode, then pressure induced light leakage (occurring in a location indicated by the dotted line in FIG. 6) occurs more severely than in other liquid crystal modes.

In addition to such a PVA mode LCD panel, in the case of a super patterned vertical alignment (“S-PVA”) mode LCD panel (in which a unit pixel is divided into two sub-pixels and different voltages are applied to the respective sub-pixels to improve a viewing angle), pressure induced light leakage is more severe than for LCD panels in other liquid crystal modes, as is the case with the PVA mode LCD panel. Although the exemplary LCD and driving method embodiments described herein are primarily applied to the PVA and S-PVA mode LCD panels, it will be appreciated that they are not limited thereto, but may be applied to LCD panels with other liquid crystal modes.

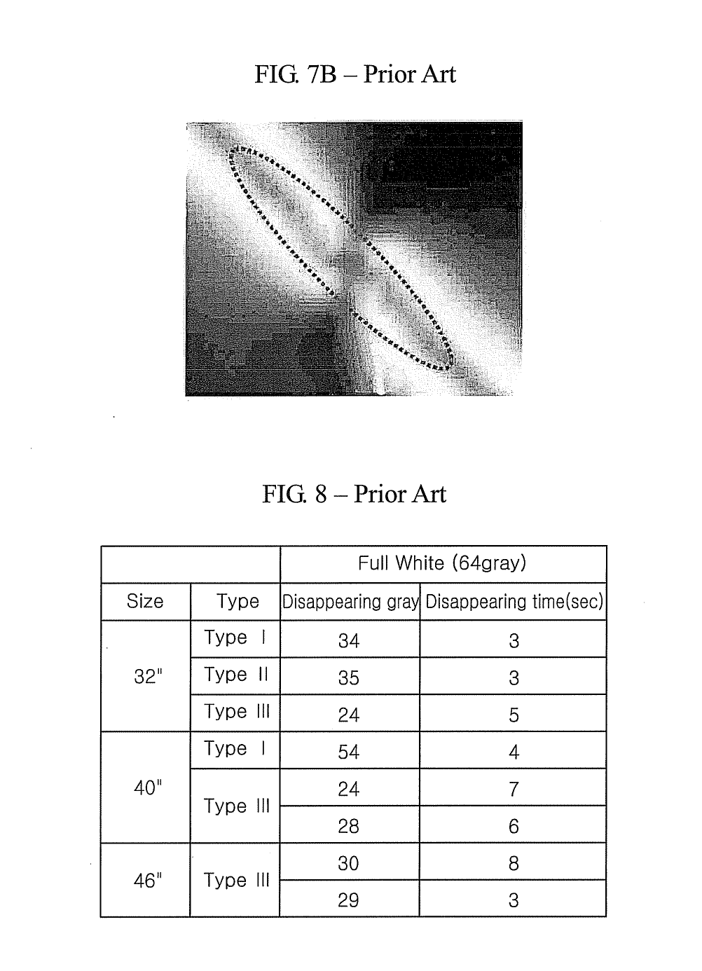

FIGS. 7A and 7B are photographs illustrating surface states of a conventional LCD panel before and after an external force is applied thereto, respectively. FIG. 8 is a table showing the time required until pressure induced light leakage disappears after an external force is applied to a conventional LCD.

Referring to the table shown in FIG. 8, the table indicates disappearing gray and time when pressure induced light leakage disappears after an external force is applied to a conventional LCD. In the example illustrated, the gray scale of a gamma voltage is set using 64 as a reference. The “disappearing gray” values in the table refer to a gray scale value at which pressure induced light leakage is not recognized when gray is lowered from full white (64 gray scales). Further, Type I refers to a S-PVA mode LCD panel in which the length of a unit pixel is normal; Type II refers to a PVA mode LCD panel in which the length of a unit pixel is normal; and Type III refers to a S-PVA mode LCD panel in which the length of a unit pixel is elongated.

As can be seen, the time taken until pressure induced light leakage disappears after an external force is applied to various types of conventional LCD panels (PVA or S-PVA mode) ranges anywhere from about 3 to 8 seconds. In contrast, since an LCD panel of the LCD according to the present invention embodiments is driven by a non-electric field every 60th to 120th frame, the effects of pressure induced light leakage are made to disappear within about 1 to 2 seconds.

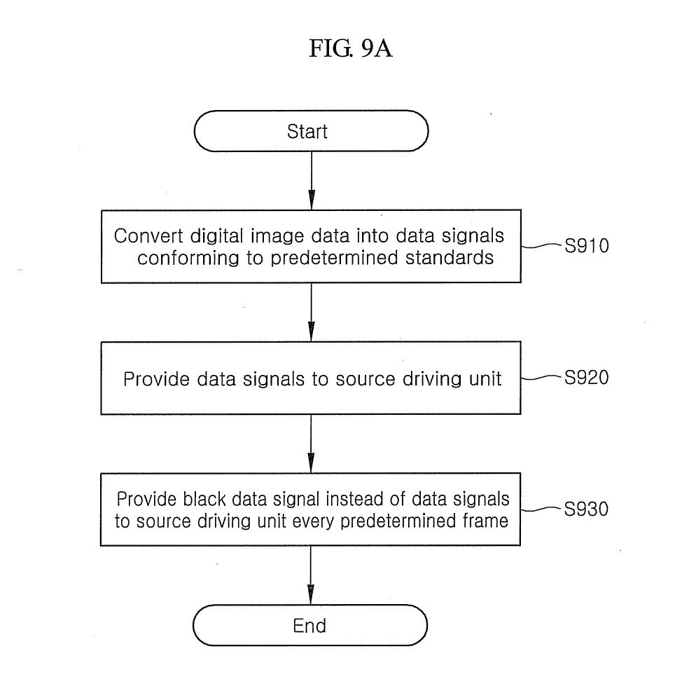

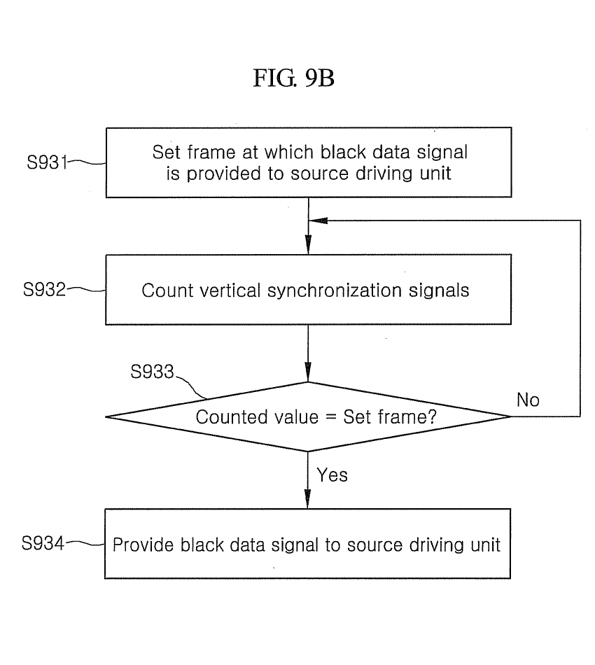

FIGS. 9A and 9B are flowcharts illustrating a method for driving an LCD device according to an embodiment of the present invention.

Referring to FIGS. 9A and 9B, externally supplied image data are initially converted into data signals conforming to a predetermined data transmission scheme (S910). Next, the converted data signals are provided to the source driving unit, with the source driving unit supplying the data signals to the LCD panel in accordance with a gate signal of the gate driving unit (S920).

The supply of the data signals is interrupted at each predetermined frame, (e.g., from the 60th to the 120th frame), in lieu of which a black data signal is generated and supplied to the source driving unit. The source driving unit supplies such a black data signal to the LCD panel so that the LCD panel is driven in a non-electric field state (S930).

The aforementioned supplying of the black data signal to the LCD panel is illustrated in further detail with reference to FIG. 9B. A frame at which the black data signal will be supplied to the source driving unit is first set (S931).

Then, vertical synchronization signals (each of which initiates the start of one frame) are counted so as to count the value of a current frame (S932). Next, the values set frame and the counted frame are compared with each other (S933). If it is determined from the comparison that the set frame and the counted frame do not match one other, the procedure goes back to block S932. On the other hand, if both the set frame and the counted frame match one other, then the black data signal is provided to the source driving unit.

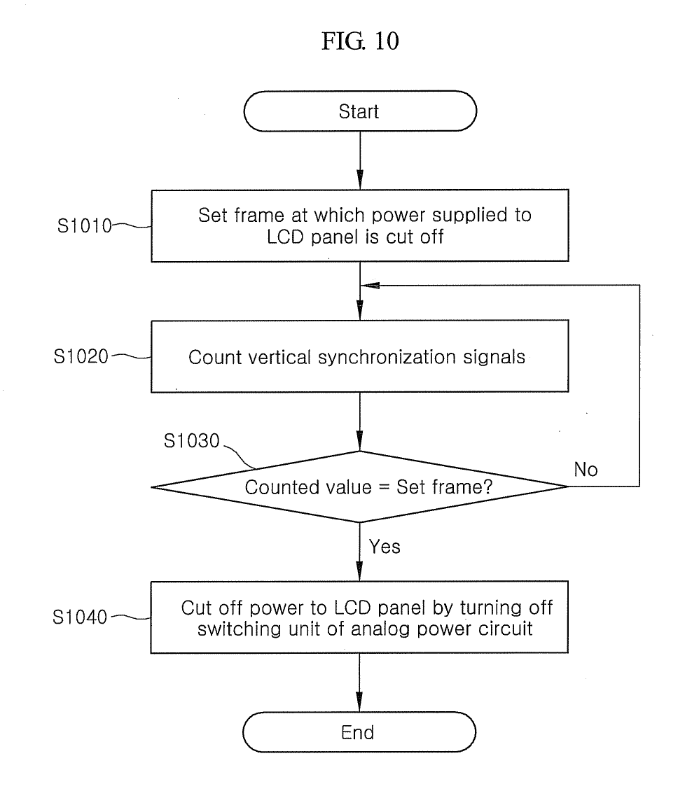

FIG. 10 is a flowchart illustrating a method for driving an LCD device according to another embodiment of the present invention.

Referring to FIG. 10, externally applied DC power is initially converted into a plurality of driving voltages to be supplied to an LCD panel (not shown). Then, a frame at which a driving voltage to be supplied to the LCD panel is to be cut off is set in order to interrupt the supply of at least a portion of the plurality of driving voltages every predetermined frame (e.g., the 60th to the 120th frame) (S1010). Next, vertical synchronization signals (each of which initiates the start of one frame) are counted so as to count the value of a current frame (S1020). Thereafter, the set frame and the counted frame are compared with each other (S1030).

If it is determined from the comparison that both the set frame and the counted frame do not match one other, the procedure goes back to block S1020. On the other hand, if both the set frame and the counted frame match other, the switching unit of the analog power circuit is turned off so as to cut off the driving voltages supplied to the LCD panel. Accordingly, the LCD panel is driven in a non-electric field state.

As described above, according to the present invention embodiments, black data is displayed and/or power supplied to an LCD panel is cut off at every predetermined interval so that the state of pixels of the LCD panel are changed into a non-electric field state, thereby shortening the time taken until pressure induced light leakage disappears after an external force is applied to the LCD panel.

The foregoing is merely exemplary embodiments of a liquid crystal display and a method for driving the same according to the present invention. Thus, the present invention is not limited thereto. It will be readily understood by those skilled in the art that various modifications and changes can be made thereto within the technical spirit and scope of the present invention defined by the appended claims.

WHAT IS CLAIMED IS:

1. A liquid crystal display (LCD) device, comprising:
an LCD panel having a plurality of gate lines, a plurality of data lines formed in a direction to intersect the plurality of gate lines, and a plurality of unit pixels respectively formed at intersection regions of the plurality of gate and data lines;
a power circuit for generating a plurality of driving voltages for driving the LCD panel;
a gate driving unit for driving the plurality of gate lines;
a source driving unit for driving the plurality of data lines; and
a timing control circuit for generating plurality of control signals for controlling the gate and source driving units,
wherein the timing control circuit is configured to drive the LCD panel in a non-electric field state at each of a predetermined frame.

2. The LCD device as claimed in claim 1, wherein the timing control circuit comprises:
a data conversion unit for converting externally supplied image data into data signals conforming to a predetermined data transmission scheme and for supplying the data signals to the source driving unit;
a control signal generation unit for generating the plurality of control signals for controlling the gate and source driving units; and
a black data generation unit for generating a black data signal at each predetermined frame and for providing the black data signal to the source driving unit.

3. The LCD device as claimed in claim 2, further comprising:
a memory for storing the value of a target frame therein;
a counter for counting the value of a current frame; and
a comparator for comparing the value of the target frame stored in the memory with the value of the current frame counted in the counter and for outputting one or more of: a black data generation unit control signal for controlling the black data generation unit and a data conversion unit control signal for controlling the data conversion unit.

4. The LCD device as claimed in claim 3, wherein the counter counts vertical synchronization signals among the plurality of control signals output from the control signal generation unit.

5. The LCD device as claimed in claim 3, wherein the comparator outputs the black data generation unit control signal whenever the value of the target frame stored in the memory and the value of the current frame counted in the counter match one other, and outputs the data conversion unit control signal whenever the value of the target frame stored in the memory and the value of the current frame counted in the counter do not match one other.

6. The LCD device as claimed in claim 5, wherein the black data generation unit control signal is input to the counter so that the counter is reset.

7. The LCD device as claimed in claim 1, wherein the timing control circuit comprises a data conversion unit for converting externally supplied image data into data signals conforming to a predetermined data transmission scheme and for supplying the data signals to the source driving unit, and a control signal generation unit for generating the plurality of control signals for controlling the gate and source driving units;
the power circuit comprises a DC-to-DC converter for converting DC power into the plurality of driving voltages, and a switching unit for controlling the supply of the plurality of driving voltages output from the DC-to-DC converter to the gate and source driving units; and
the switching unit interrupts the supply of at least a portion of the plurality of driving voltages to any one of the gate and source driving units at each predetermined frame.

8. The LCD device as claimed in claim 7, further comprising:
a memory for storing the value of a target frame therein;
a counter for counting the value of a current frame; and
a comparator for comparing the value of the target frame stored in the memory with the value of the current frame counted in the counter;
wherein the control signal generation unit receives an output signal from the comparator and generates a switching unit control signal for controlling the switching unit.

9. The LCD device as claimed in claim 8, wherein the counter counts vertical synchronization signals among the plurality of control signals output from the control signal generation unit.

10. The LCD device as claimed in claim 9, wherein the control signal generation unit comprises a switching unit control signal generation circuit for generating the switching unit control signal; and
the switching unit control signal generation circuit comprises a plurality of switching elements activated according to the output signal of the comparator only at the predetermined frame so as to output a switching unit disable signal to the switching unit; and
a resistor and a capacitor for controlling duration time of the disable signal.

11. The LCD device as claimed in claim 1, wherein the predetermined frame is selected from the 60th frame to the 120th frame.

12. The LCD device as claimed in claim 1, wherein the LCD panel comprises:
an upper substrate having a common electrode with a cut-out pattern formed therein;
a lower substrate having a pixel electrode with a cut-out pattern formed therein; and
liquid crystals disposed between the upper and lower substrates.

13. A method for driving a liquid crystal display (LCD) device, the method comprising:
converting externally supplied image data into data signals conforming to a predetermined data transmission scheme;
supplying the data signals to an LCD panel; and
interrupting the supply of the data signals, generating a black data signal and supplying the black data signal to the LCD panel at each of a predetermined frame.

14. The method as claimed in claim 13, wherein supplying the black data signal to the LCD panel comprises:
setting the value of a target frame;
counting the value of a current frame; and
comparing the value of the target frame with the value of the current frame and supplying the black data signal to the LCD panel according to the result of the comparison.

15. The method as claimed in claim 13, wherein the predetermined frame is selected from the 60th frame to the 120th frame.

16. A method for driving a liquid crystal display (LCD) device, the method comprising:
converting DC power into a plurality of driving voltages;
supplying the plurality of driving voltages to an LCD panel; and
interrupting the supply of at least a portion of the plurality of driving voltages at each of a predetermined frame.

17. The method as claimed in claim 16, wherein interrupting the supply of at least a portion of the plurality of driving voltages comprises:
setting the value of a target frame;
counting the value of a current frame; and
comparing the value of the target frame with the value of the current frame and interrupting the supply of at least a portion of the plurality of driving voltages according to the result of the comparison.

18. The method as claimed in claim 16, wherein the predetermined frame is selected from the 60th frame to the 120th frame.
